(19) United States
(12) Patent Application Publication
(10) Pub. No.: US 2019/0228234 A1
(43) Pub. Date: Jul. 25, 2019

(54) CONGESTION SENSING DEVICE, CONGESTION SENSING SYSTEM, AND CONGESTION SENSING METHOD

(71) Applicant: PANASONIC INTELLECTUAL PROPERTY MANAGEMENT CO., LTD., Osaka (JP)

(72) Inventor: Hiroki TESHIMA, Kanagawa (JP)

(73) Assignee: PANASONIC INTELLECTUAL PROPERTY MANAGEMENT CO., LTD., Osaka (JP)

(21) Appl. No.: 16/329,482

(22) PCT Filed: Aug. 28, 2017
(86) PCT No.: PCT/JP2017/030649

§ 371 Date: Feb. 28, 2019

(30) Foreign Application Priority Data
Sep. 6, 2016 (JP) 2016-173533

(51) Int. Cl. G06K 9/00; G06K 9/20; G06T 7/20; G08B 5/36

(52) U.S. Cl. CPC G06K 9/00778; G06K 9/2081; G06T 2207/30232; G08B 5/36; G06T 2207/30196; G06T 7/20

(57) ABSTRACT

A supervisor can ascertain an occurrence of a congestion state in advance by performing an appropriate notification prior to reaching the congestion state. There is provided an area setting unit that sets at least two determination areas on the captured image in response to an input operation of a user, a person sensor that senses a person existing within the determination area from the captured image, a congestion degree calculator that calculates a congestion degree for each of the determination areas based on a sensing result by the person sensor, a state sensor that compares the congestion degree calculated by the congestion degree calculator with predetermined reference values for each of the determination areas, and senses a plurality of states including a congestion state and a potential congestion state, and an output unit that outputs information for performing a notification action based on the sensing result by the state sensor.

### TECHNICAL FIELD

The present disclosure relates to a congestion sensing device, a congestion sensing system, and a congestion sensing method for sensing a congestion state of a moving object in a monitoring area based on a captured image in which the monitoring area is imaged.

### BACKGROUND ART

In various facilities such as stations, a monitoring system is widely used in which a camera for imaging a monitoring area is installed, a captured image of the camera is displayed on a monitor, and a condition of a user in the monitoring area is monitored.

In such a monitoring system, a supervisor can ascertain a congestion state of the monitoring area by visually checking the captured image of the camera, but it is very laboriously to constantly continue such work. In the related art, there is a known technology of sensing a congestion state of a person in a monitoring area based on a captured image in which the monitoring area is imaged by with the camera, and notifying a supervisor of the congestion state in real time (see PTL 1).

### CITATION LIST

### Patent Literature

PTL 1: Japanese Patent No. 5070376
PTL 2: Japanese Patent Unexamined Publication No. 2007-243342

### SUMMARY OF THE INVENTION

When the inside of a facility is in a congestion state, an on-site response will be performed for eliminating the congestion such as guiding users but if the congestion state is sensed in advance and the on-site response is started at an early stage, then the on-site response can be efficiently performed. However, in the technology of the related art, there is no consideration relating to ascertaining the occurrence of such congestion in advance and there is a problem that it is not possible to efficiently perform the on-site response for eliminating the congestion state.

The present disclosure aims to provide a congestion sensing device, a congestion sensing system, and a congestion sensing method capable of allowing a supervisor to ascertain an occurrence of a congestion state in advance by performing an appropriate notification prior to a congestion state being reached.

According to an aspect of the present disclosure, there is provided a congestion sensing device for sensing a congestion state of a moving object in a monitoring area based on a captured image in which the monitoring area is imaged, the device being configured to include: an area setting unit that sets at least two determination areas on the captured image in response to an input operation of a user; a moving object sensor that senses a moving object existing within the determination area from the captured image; a congestion degree calculator that calculates a congestion degree for each of the determination areas based on a sensing result by the moving object sensor; a state sensor that compares the congestion degree calculated by the congestion degree calculator with predetermined reference values for each of the determination areas, and senses a plurality of states including a congestion state and a potential congestion state; and an output unit that outputs information for performing a notification action based on the sensing result by the state sensor.

According to another aspect of the present disclosure, there is provided a congestion sensing system for sensing a congestion state of a moving object in a monitoring area based on a captured image in which the monitoring area is imaged, the system being configured to include: a camera that images the monitoring area; and a congestion sensing device, in which the congestion sensing device includes: an area setting unit that sets at least two determination areas on the captured image in response to an input operation of a user; a moving object sensor that senses a moving object existing within the determination area from the captured image; a congestion degree calculator that calculates a congestion degree for each of the determination areas based on a sensing result by the moving object sensor; a state sensor that compares the congestion degree calculated by the congestion degree calculator with predetermined reference values for each of the determination areas, and senses a plurality of states including a congestion state and a potential congestion state; and an output unit that outputs information for performing a notification action based on the sensing result by the state sensor.

According to still another aspect of the present disclosure, there is provided a congestion sensing method for causing an information processing device to perform a process of sensing a congestion state of a moving object in a monitoring area based on a captured image in which the monitoring area is imaged, the method being configured to include: setting at least two determination areas on the captured image in response to an input operation of a user; sensing a moving object existing within the determination area from the captured image; calculating a congestion degree for each of the determination areas based on a sensing result by the moving object sensor; comparing the congestion degree calculated by the congestion degree calculator with predetermined reference values for each of the determination areas, and sensing a plurality of states including a congestion state and a potential congestion state; and outputting information for performing a notification action based on the sensing result by the state sensor.

According to the present disclosure, a potential congestion state, that is, a state having a high possibility of becoming a congestion state can be sensed, and a supervisor can ascertain an occurrence of the congestion state in advance by performing a notification relating to the potential congestion state. Accordingly, an on-site response can be efficiently performed for eliminating the congestion state.

### BRIEF DESCRIPTION OF DRAWINGS

FIG. 1 is an overall configuration diagram of a congestion sensing system according to a present exemplary embodiment.

FIG. 2 is an explanatory diagram showing congestion determination area 12 and potential congestion determination area 13 set on camera image 11.

FIG. 3 is a block diagram showing a schematic configuration of congestion sensing device 2.

FIG. 4 is an explanatory diagram showing a monitoring screen displayed on monitor 21.

FIG. 5 is an explanatory diagram showing state display icons 52 displayed on the monitoring screen of monitor 21 and transition condition of lamp 31 of notification device 3.

FIG. 6 is an explanatory diagram showing an outline of notification actions performed by notification device 3.

FIG. 7 is an explanatory diagram showing an outline of processing performed by state sensor 45.

FIG. 8 is an explanatory diagram showing a setting screen displayed on monitor 21.

FIG. 9A is an explanatory diagram showing area setting unit 63 of the setting screen in detail.

FIG. 9B is an explanatory diagram showing area setting unit 63 of the setting screen in detail.

FIG. 10 is an explanatory diagram showing threshold value setting unit 64 of the setting screen in detail.

FIG. 11 is an explanatory diagram showing another example of potential congestion determination area 13.

FIG. 12 is an explanatory diagram showing still another example of potential congestion determination area 13.

### DESCRIPTION OF EMBODIMENTS

In a first invention for solving the above-described problem, a congestion sensing device for sensing a congestion state of a moving object in a monitoring area based on a captured image in which the monitoring area is imaged, the device is configured to include: an area setting unit that sets at least two determination areas on the captured image in response to an input operation of a user; a moving object sensor that senses a moving object existing within the determination area from the captured image; a congestion degree calculator that calculates a congestion degree for each of the determination areas based on a sensing result by the moving object sensor; a state sensor that compares the congestion degree calculated by the congestion degree calculator with predetermined reference values for each of the determination areas, and senses a plurality of states including a congestion state and a potential congestion state; and an output unit that outputs information for performing a notification action based on the sensing result by the state sensor.

According to the first invention, a potential congestion state, that is, a state having a high possibility of becoming a congestion state can be sensed, and a supervisor can ascertain an occurrence of the congestion state in advance by performing a notification with respect to the potential congestion state. Accordingly, an on-site response can be efficiently performed for eliminating the congestion state.

In a second invention, the area setting unit is configured to set a congestion determination area, which is an object of a congestion determination for determining whether or not it is in the congestion state, and a potential congestion determination area, which is an object of a potential congestion determination for determining whether or not it is in the potential congestion state, as the determination area.

According to the second invention, since the potential congestion determination area is set separately from the congestion determination area, the potential congestion state can be accurately sensed.

In a third invention, the reference values are configured to set to different values for each of the determination areas.

According to the third invention, a plurality of states including the potential congestion state can be accurately sensed.

In a fourth invention, the state sensor is configured to sense three states of a normal state, a potential congestion state, and a congestion state, and the output unit is configured to output information for performing a notification action according to the three states.

According to the fourth invention, since the notification action is performed according to the three states of the normal state, the potential congestion state, and the congestion state, the supervisor can easily ascertain which state it is in.

In a fifth invention, the output unit is configured to output control information for changing a lighting state of a lamp based on the sensing result by the state sensor to a notification device including the lamp.

According to the fifth invention, since the potential congestion state is notified due to a difference in the lighting state of the lamp, the supervisor can easily ascertain the potential congestion state.

In a sixth invention, the area setting unit is configured to set a plurality of potential congestion determination areas, which are objects of potential congestion determination for determining whether or not it is in a potential congestion state on the captured image.

According to the sixth invention, since the potential congestion state is determined with the plurality of potential congestion determination areas, the potential congestion state can be accurately sensed.

In a seventh invention, the congestion sensing device further includes a reference value setting unit that causes a display device to display the setting screen and sets the reference value in response to an input operation of a user, in which the reference value setting unit is configured to cause the setting screen to display an actual result value of the congestion degree in the past.

According to the seventh invention, the user can freely change the reference value. In addition, since the actual result value of the degree of the congestion is displayed, the reference value can be set with reference to the actual result value of the degree of the congestion. Accordingly, an appropriate reference value can be easily set.

In an eighth invention, a congestion sensing system for sensing a congestion state of a moving object in a monitoring area based on a captured image in which the monitoring area is imaged, the system is configured to include: a camera that images the monitoring area; and a congestion sensing device, in which the congestion sensing device includes: an area setting unit that sets at least two determination areas on the captured image in response to an input operation of a user; a moving object sensor that senses a moving object existing within the determination area from the captured image; a congestion degree calculator that calculates a congestion degree for each of the determination areas based on a sensing result by the moving object sensor; a state sensor that compares the congestion degree calculated by the congestion degree calculator with predetermined reference values for each of the determination areas, and senses a plurality of states including a congestion state and a potential congestion state; and an output unit that outputs information for performing a notification action based on the sensing result by the state sensor.

According to the eighth invention, as in the first invention, the supervisor can ascertain the occurrence of the congestion state in advance by performing an appropriate notification prior to the congestion state being reached.

In a ninth invention, a congestion sensing method for causing an information processing device to perform a process of sensing a congestion state of a moving object in a monitoring area based on a captured image in which the monitoring area is imaged, the method is configured to include: setting at least two determination areas on the captured image in response to an input operation of a user; sensing a moving object existing within the determination area from the captured image; calculating a congestion degree for each of the determination areas based on a sensing result by the moving object sensor; comparing the congestion degree calculated by the congestion degree calculator with predetermined reference values for each of the determination areas, and sensing a plurality of states including a congestion state and a potential congestion state; and outputting information for performing a notification action based on the sensing result by the state sensor.

According to the ninth invention, as in the first invention, the supervisor can ascertain the occurrence of the congestion state in advance by performing an appropriate notification prior to the congestion state being reached.

Hereinafter, an exemplary embodiment will be described with reference to the drawings.

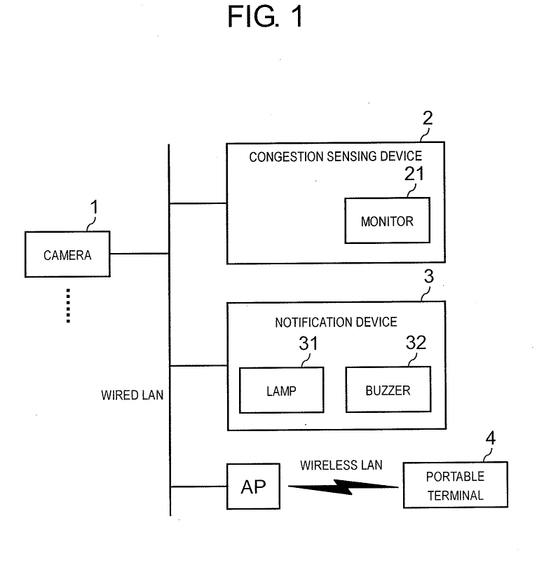

FIG. 1 is an overall configuration diagram of a congestion sensing system according to the present exemplary embodiment.

The congestion sensing system senses a congestion state of a person (moving object) in a monitoring area inside a facility such as a station, notifies a supervisor of the congestion state of the monitoring area, and includes camera 1, congestion sensing device 2, notification device 3, and portable terminal 4.

Camera 1, congestion sensing device 2, and notification device 3 are mutually connected via a wired LAN. Portable terminal 4 is connected to congestion sensing device 2 via a wireless LAN. Note that the exemplary embodiment is not limited to such wired LAN and wireless LAN, and any suitable communication method may be adopted.

Camera 1 images the monitoring area in the facility. Camera 1 transmits the captured image (camera image) of the monitoring area to congestion sensing device 2 via a local area network.

Congestion sensing device 2 is configured with an information processing device such as a PC, and an application program for a congestion sensing is installed. In congestion sensing device 2, a camera image transmitted from camera 1 is received, people are detected from the camera image, and processing for sensing a congestion state of a person in the monitoring area is performed. Congestion sensing device 2 includes monitor (display device) 21, and a camera image is displayed on a monitoring screen of monitor 21, so that the supervisor can check the actual condition of the monitoring area. The congestion state is displayed on the monitoring screen of monitor 21, and the congestion state is notified to the supervisor. Further, congestion sensing device 2 transmits control information for controlling notification device 3 via a wired LAN.

Notification device 3 includes lamp 31 and buzzer 32, and notifies the supervisor of the congestion state by turning on lamp 31 and sounding buzzer 32. In notification device 3, the control information transmitted from congestion sensing device 2 is received, and lamp 31 and buzzer 32 perform a predetermined notification action based on the control information.

Portable terminal 4 is a smart phone, a tablet terminal or the like and is possessed by an employee such as a station staff member, and the monitoring screen similar to monitor 21 of the congestion sensing device 2 can be displayed by accessing congestion sensing device 2, so that the employee can check the condition of the monitoring area at any place. In addition, in synchronization with the notification action in notification device 3, portable terminal 4 may receive notifications such as transmission of an electronic mail and display of a predetermined alert screen.

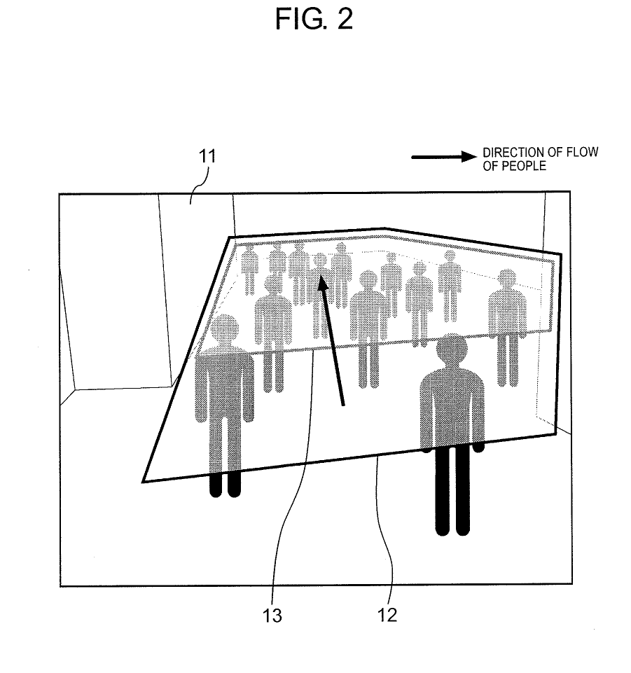

Next, the congestion determination area and the potential congestion determination area will be described. FIG. 2 is an explanatory diagram showing congestion determination area 12 and potential congestion determination area 13 set on camera image 11.

In the present exemplary embodiment, the monitoring area in the facility is imaged by the camera, captured image (camera image) 11 of the camera is displayed on monitor 21 of congestion sensing device 2, and the supervisor can check the actual condition of the monitoring area.

In congestion sensing device 2, a congestion state of a person is sensed in the monitoring area based on camera image 11 and processing for notifying the supervisor of the congestion state is performed. In the processing, a congestion determination for determining whether or not it is in the congestion state is performed, and congestion determination area 12, which is an object of the congestion determination is set in advance on camera image 11.

Furthermore, in the present exemplary embodiment, in order to start an on-site response for eliminating the congestion state at an early stage, the potential congestion state, that is, a state having a high possibility of becoming a congestion state can be sensed, and the potential congestion state is notified to the supervisor. At this time, a potential congestion determination for determining whether or not it is in a potential congestion state is performed, and potential congestion determination area 13, which is an object of the potential congestion determination is set in advance on the captured image.

In the example shown in FIG. 2, people pass through from a near side toward a far side, and there is a place which causes a congestion on the far side (for example, a ticket gate of a station). Therefore, when there is a lot of passing people, a stagnation of the people starts from the far side, and as the number of passing people increases, a stagnation range of the people gradually expands toward the near side. At this time, potential congestion determination area 13 is set on the far side, and congestion determination area 12 is set so as to include potential congestion determination area 13 and an area on the near side thereof.

Note that in the process of transitioning from the normal state to the congestion state, various patterns depending on a condition of the on-site, that is, a condition of the place causing the flow of people and a congestion are included, and potential congestion determination area 13 and congestion determination area 12 may be set appropriately depending on the pattern.

In the example shown in FIG. 2, the determination area is set to a polygon composed of a plurality of straight lines, but it may be set to an appropriate shape such as a circle or an ellipse in addition to the straight lines.

In the example shown in FIG. 2, lines surrounding the determination areas 12 and 13 are set, but lines may be set so as to divide the camera image and the determination areas 12 and 13 may be set by the lines and an image frame.

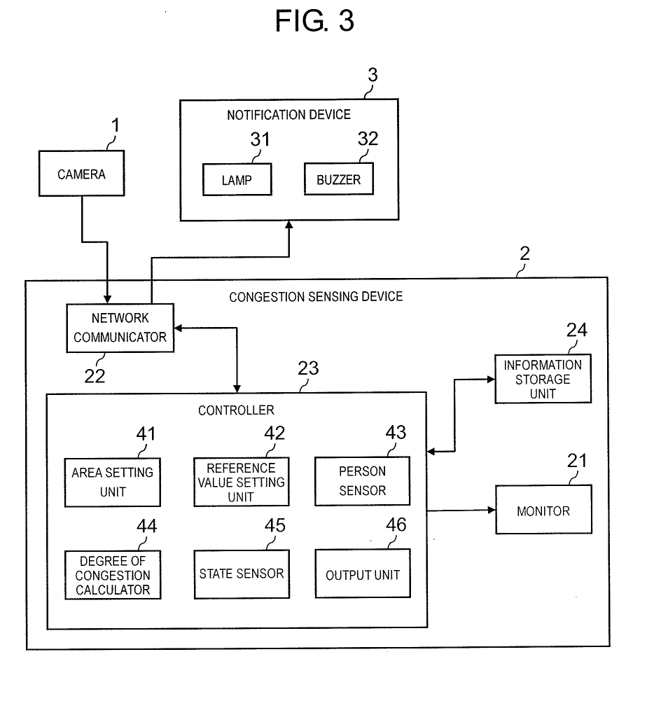

Next, a schematic configuration of congestion sensing device 2 will be described. FIG. 3 is a block diagram showing a schematic configuration of congestion sensing device 2.

Congestion sensing device 2 includes monitor 21, network communicator 22, controller 23, and information storage unit 24.

Network communicator 22 performs a communication between camera 1 and notification device 3 via a network. In the present exemplary embodiment, network communicator 22 receives a camera image transmitted from camera 1. In addition, network communicator 22 transmits control information for causing notification device 3 to perform a required notification action to notification device 3.

Information storage unit 24 stores common setting information commonly set by all users, user setting information individually set by each user, information relating to a degree of the congestion acquired by controller 23, and a program executed by controller 23.

Controller 23 includes area setting unit 41, reference value setting unit 42, person sensor 43 (moving object sensor), congestion degree calculator 44, state sensor 45, and output unit 46. Each unit of controller 23 is realized by causing a processor constituting controller 23 to execute an application program (instruction) for congestion sensing stored in information storage unit 24.

Area setting unit 41 sets a determination area on the captured image according to an input operation of a user. In the present exemplary embodiment, the area setting unit sets congestion determination area 12, which is an object of the congestion determination for determining whether or not it is in the congestion state, and potential congestion determination area 13, which is an object of the potential congestion determination for determining whether or not it is in the potential congestion state, as the determination area.

Reference value setting unit 42 displays the setting screen on monitor 21 and sets threshold values (reference values) for each of a plurality of determination areas (congestion determination area and potential congestion determination area) according to an input operation of a user. That is, a threshold value used for the congestion determination for determining whether or not it is in the congestion state and a threshold value used for the potential congestion determination for determining whether or not it is in a potential congestion state, are set. At this time, reference value setting unit 42 acquires an actual result value of the congestion degree in the past from information storage unit 24, and displays the actual result value of the congestion degree on the setting screen. Accordingly, the user can correct the threshold value by checking the actual result value of the congestion degree, so that the threshold value can be appropriately reviewed.

Person sensor 43 senses a person existing in the determination area from the camera image. Known technologies may be used for sensing a person, for example, a current camera image and a moving object removed image (background image) are compared and a moving object in the camera image is detected from the difference between the current camera image and the moving object removed image, and then the moving object is determined as a person when a Ω shape composed of a face of a person or a head and shoulder of a person is detected in the image region of the moving object.

Congestion degree calculator 44 calculates the congestion degree for each determination area (congestion determination area and potential congestion determination area) based on the sensing result by person sensor 43. At this time, the number of people in the determination area is obtained from the sensing result of person sensor 43, and the ratio of the number of people in the determination area to the maximum number of people assumed in the determination area may be calculated as the congestion degree.

The congestion degree includes a movement congestion representing the congestion degree in a state where people are moving and a stagnation congestion representing the congestion degree in a state where people are stagnated with no movement. In the present exemplary embodiment, the congestion degree is calculated focusing on the stagnation congestion.

The congestion degree can be calculated by the following equation using the weighting coefficients α and β based on both the movement congestion and the stagnation congestion. Congestion degree=movement congestion×α+stagnation congestion×β. α+β=1. Note that α=0 and β=1 may be used so that the congestion degree can be obtained only from the stagnation congestion. The weighting coefficients α and β are stored in information storage unit 24 as common setting information or user setting information.

Based on the congestion degree calculated by congestion degree calculator 44, state sensor 45 senses a state related to the congestion in the monitoring area. In the present exemplary embodiment, the congestion determination and the potential congestion determination are performed, and based on the determination result, three states of a normal state (non-congestion state), a potential congestion state, and a congestion state are sensed.

In the congestion determination, it is determined whether or not it is in the congestion state by comparing the congestion degree in the congestion determination area with the threshold value used for the congestion determination. In the potential congestion determination, it is determined whether or not it is in a potential congestion state by comparing the congestion degree in the potential congestion determination area with the threshold value used for the potential congestion determination.

The normal state is sensed when the congestion state is not sensed with the congestion determination and the potential congestion state is not sensed with the potential congestion determination. The potential congestion state is sensed when the congestion state is not sensed with the congestion determination and the potential congestion state is sensed with the potential congestion determination. Further, the congestion state is sensed with priority given to the congestion determination result regardless of the potential congestion determination result, when the congestion state is sensed with the congestion determination.

Output unit 46 outputs information for performing a notification action based on the sensing result by state sensor 45. In the present exemplary embodiment, the notification action is performed by monitor 21 and notification device 3. That is, display information is outputted to monitor 21, and a user is notified of a state relating to the congestion (normal state, potential congestion state, and congestion state) on the screen of monitor 21. In addition, control information for causing notification device 3 to perform a predetermined notification action is output to notification device 3, and in notification device 3, the user is notified of a state relating to the congestion by turning on lamp 31 and sounding buzzer 32.

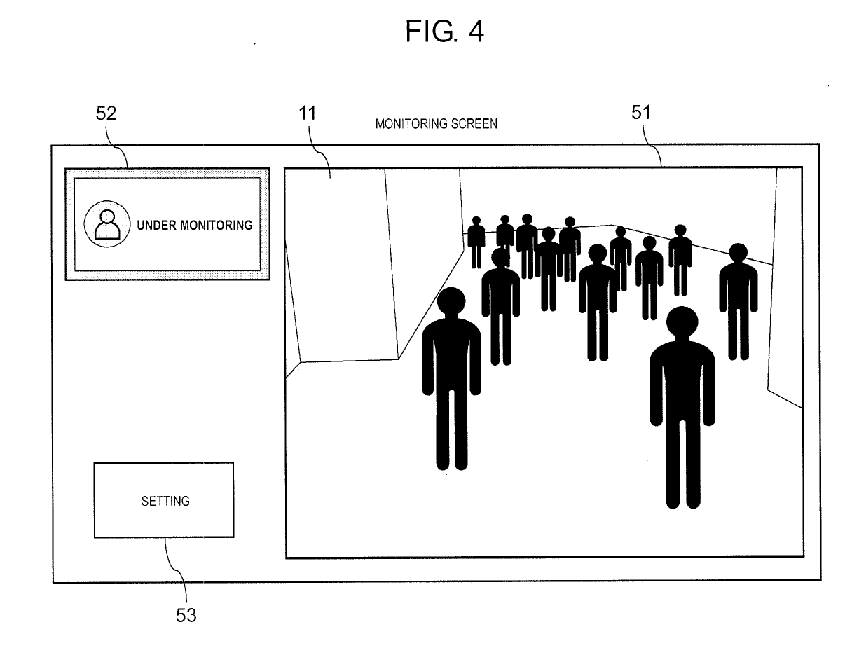

Next, a monitoring screen displayed on monitor 21 will be described. FIG. 4 is an explanatory diagram showing the monitoring screen.

A supervisor monitors a condition of the monitoring area with the monitoring screen. The monitoring screen is an initial screen displayed when an application is activated.

Camera image displayer 51 is provided on the monitoring screen and camera image 11 imaged the monitoring area is displayed on camera image displayer 51, and the supervisor can check the actual condition of the monitoring area.

State display icon 52 (state displayer) is displayed on the monitoring screen and a state (normal state, potential congestion state, and congestion state) relating to the congestion in the monitoring area is notified to the supervisor by state display icon 52.

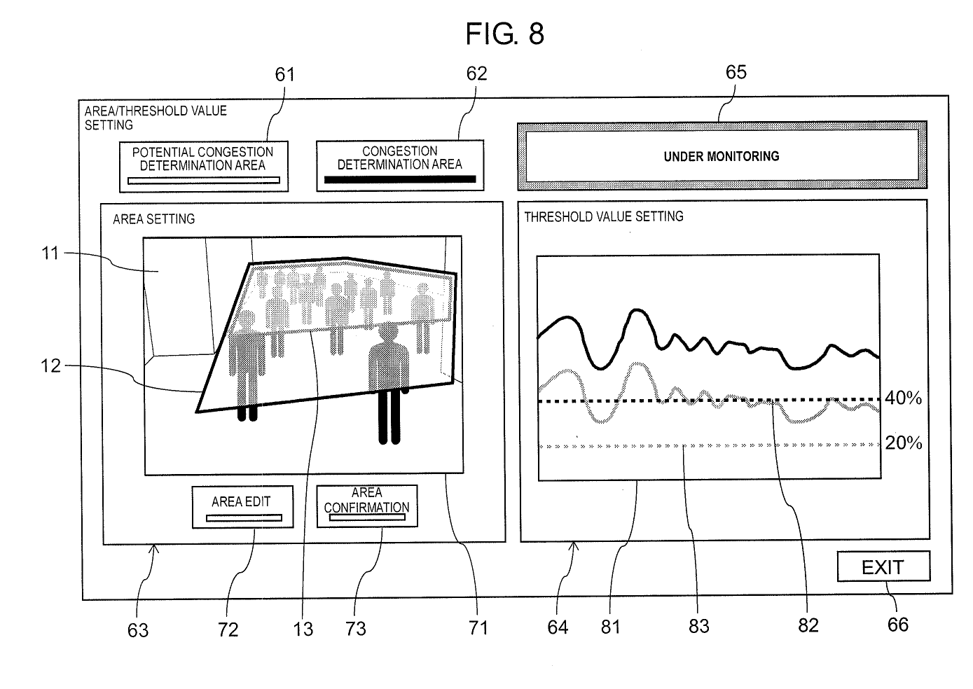

Further, setting button 53 is provided on the monitoring screen. A transition is made to a setting screen (see FIG. 8) when setting button 53 is operated.

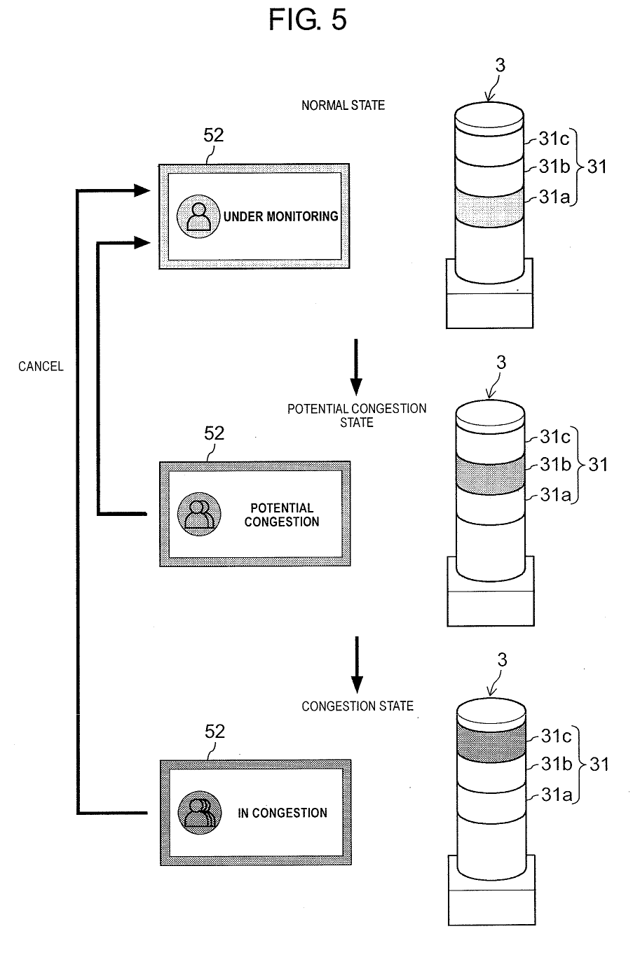

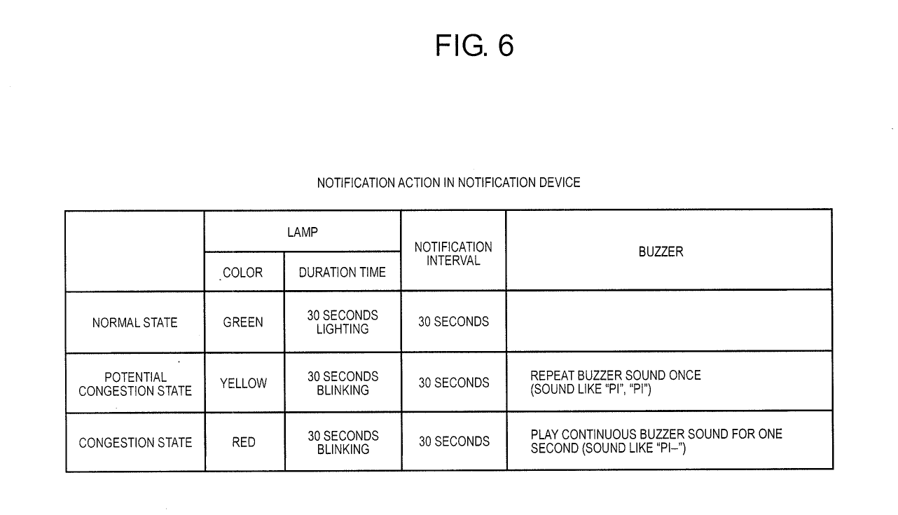

Next, a notification action performed by monitor 21 and notification device 3 will be described. FIG. 5 is an explanatory diagram showing state display icons 52 displayed on the monitoring screen of monitor 21 and transition condition of lamp 31 of notification device 3. FIG. 6 is an explanatory diagram showing an outline of notification actions performed by notification device 3.

In state sensor 45 of congestion sensing device 2, three states of a normal state, a potential congestion state and a congestion state are sensed, a notification action based on the sensing result of state sensor 45 is performed in association with monitor 21 and notification device 3, and a state (normal state, potential congestion state, and congestion state) relating to the congestion is notified to the supervisor.

As shown in FIG. 5, in a normal state, a notification action corresponding to the normal state is performed. If a potential congestion state is sensed here, the notification action is switched to an action corresponding to the potential congestion state. Furthermore, if a congestion state is sensed, the notification action is switched to an action corresponding to the congestion state. In addition, if the normal state is sensed when it is in the potential congestion state or the congestion state, the potential congestion state and the congestion state are canceled, the state is returned to the normal state, and the notification action is switched to the action corresponding to the normal state.

On monitor 21, state display icon 52 is displayed on the monitoring screen (see FIG. 4), and the supervisor is notified of whether it is in a normal state, a potential congestion state, or a congestion state by changing a display form of state display icon 52.

More specifically, in the normal state, state display icon 52 is displayed in green, and characters “under monitoring” are displayed on state display icon 52. In the potential congestion state, state display icon 52 is displayed in yellow, and characters “potential congestion” are displayed on state display icon 52. In the congestion state, state display icon 52 is displayed in red, and characters “in congestion” are displayed on state display icon 52.

On the other hand, in notification device 3 shown in FIG. 5, green, yellow, and red lamps 31a, 31b, and 31c are provided, and the supervisor is notified of whether it is in a normal state, a potential congestion state, or a congestion state by changing a lighting state of lamps 31a, 31b, and 31c.

Specifically, as shown in FIG. 6, in the normal state, green lamp 31a is turned on. In the potential congestion state, yellow lamp 31b blinks. In the congestion state, red lamp 31c blinks.

In addition to the lighting of the lamps 31, notification device 3 notifies the supervisor that the state has been changed to the potential congestion state or the congestion state by sounding buzzer 32. At this time, different buzzer sounds are used for the potential congestion state and the congestion state. Specifically, when the state is changed to the potential congestion state, an intermittent buzzer sound is sounded, and when the state is changed to the congestion state, a continuous buzzer sound is sounded.

In the example shown in FIG. 6, notification intervals are set to 30 seconds, and in lamps 31, since a duration time coincides with the notification interval, the lighting state or the blinking state of lamps 31 are constantly continued. In buzzer 32, since a duration time is several seconds, a buzzer sound of several seconds repeatedly sounds every 30 seconds.

In notification device 3, the lighting state of lamps 31 is controlled by controller 23 of congestion sensing device 2, and in a state where an application program for the congestion sensing is not activated, lamps 31 of notification device 3 are turned off.

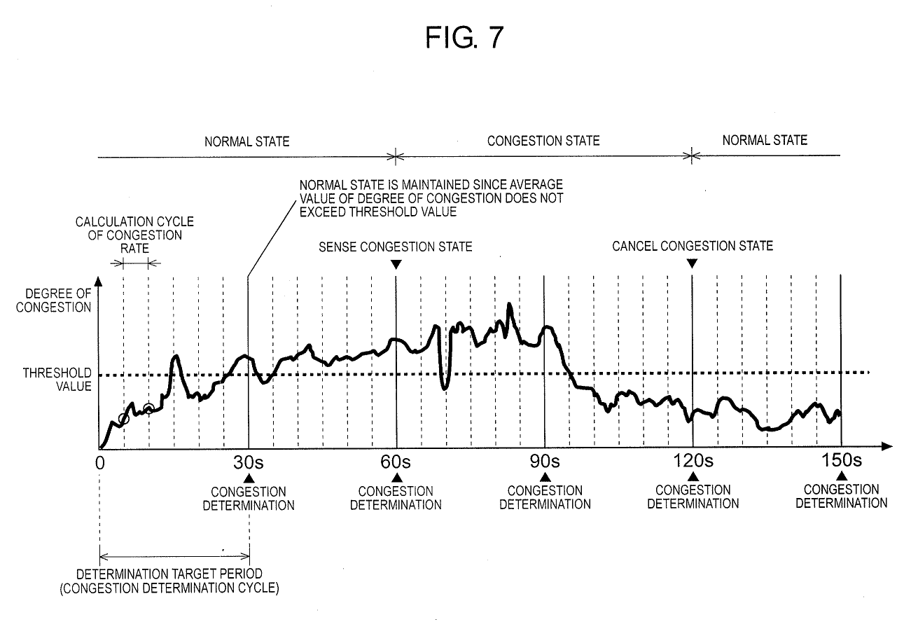

Next, processing performed by state sensor 45 of congestion sensing device 2 will be described. FIG. 7 is an explanatory diagram showing an outline of the processing performed by state sensor 45.

In state sensor 45 of congestion sensing device 2, the congestion determination is performed for determining whether or not it is in the congestion state by comparing the congestion degree in congestion determination area 12 with a threshold value used for the congestion determination. In the congestion determination, an average value of congestion rates in a predetermined determination target period is obtained from the congestion degree measured at a predetermined cycle, and it is determined that the state is in the congestion state when the average value is compared with a threshold value and the average value becomes greater than or equal to the threshold value.

In the example shown in FIG. 7, a calculation period of the congestion rate is set to 5 seconds, the determination target period is set to 30 seconds, and the congestion determination is performed every 30 seconds based on the congestion rates calculated at 5 seconds intervals. At this time, an average value of the congestion rates for six times in total is obtained by adding the current congestion rate and the congestion rates for five times in the past for every 30 seconds, and if the average value is greater than or equal to the threshold value, it is determined that the state is the congestion state.

Also, if the average value of the congestion rates in the determination target period is less than the threshold value, it is determined that the state is not the congestion state, the congestion state is canceled and the state returns to the normal state.

Further, in state sensor 45, the potential congestion determination for determining whether or not it is in the potential congestion state is performed based on the congestion degree in potential congestion determination area 13. In the potential congestion determination, as in the case of congestion determination shown in FIG. 7, an average value of congestion rates in a predetermined determination target period is obtained, and it is determined that the state is in the potential congestion state when the average value is compared with a threshold value used for the potential congestion determination and the average value becomes greater than or equal to the threshold value. Also, if the average value of the congestion rates in the determination target period is less than the threshold value, it is determined that the state is not the potential congestion state, the potential congestion state is canceled, and the state returns to the normal state.

Note that, in the present exemplary embodiment, it is determined that the state is the congestion state when the average value of the congestion rates in the determination target period is greater than or equal to the threshold value used for the congestion determination, and it is determined that the state is the potential congestion state when the average value is greater than or equal to the threshold value used for the potential congestion determination. However, the congestion determination and the potential congestion determination are not limited to such a method, and various methods are applied as long as it is possible to eliminate abnormal values of the congestion rates.

For example, processing of comparing the congestion degree with the threshold value is performed at the same time as calculating the congestion degree, and when a state in which the congestion degree is greater than or equal to the threshold value becomes dominant, that is, when the number of times that the congestion degree is greater than or equal to the threshold value becomes a majority in the predetermined determination target period, it may be determined that the state is the congestion state or the potential congestion state.

Further, in the example shown in FIG. 7, the congestion determination is performed at the timing of the determination target period, that is, the congestion determination cycle is made to coincide with the determination target period. However, the timing for executing the congestion determination is not limited to the timing of the determination target period. For example, the congestion determination may be performed with a cycle shorter than the determination target period.

In addition, the determination target period or the calculation period of the congestion rates may be set in advance as common setting information. However, the determination target period and the calculation period of the congestion rates may be changed by a user as appropriate, as user setting information.

Next, a setting screen displayed on monitor 21 will be described. FIG. 8 is an explanatory diagram showing the setting screen.

In the setting screen, a user specifies potential congestion determination area 13 and congestion determination area 12, and the threshold value used for the potential congestion determination and the threshold value used for the congestion determination. A transition is made to the setting screen when the setting button is operated on the monitoring screen (see FIG. 4) displayed when the application is activated.

On the setting screen, potential congestion determination area button 61, congestion determination area button 62, area setting unit 63, threshold value setting unit 64, state display icon 65, and EXIT button 66 are provided.

Potential congestion determination area button 61 and congestion determination area button 62 are used for switching a determination area which is an editing target (setting target), and can select either potential congestion determination area 13 or congestion determination area 12 as the editing target.

In area setting unit 63, two determination areas, namely, congestion determination area 12 and potential congestion determination area 13 are specified by a user. Area setting unit 63 will be described in detail later.

In threshold value setting unit 64, the threshold value used for the potential congestion determination and the threshold value used for the congestion determination are specified by a user. Threshold value setting unit 64 will be described in detail later.

Same as state display icon 52 on the monitoring screen (see FIG. 4), the current state of the monitoring area is displayed on state display icon 65. If the determination area and the threshold value are already set, the congestion sensing has been continuously executed in controller 23 even in a state where the setting screen is displayed, and the state sensed by the congestion sensing is notified to the supervisor by state display icon 65.

As the common setting information, entire camera image 11 is set as an initial state of congestion determination area 12 and potential congestion determination area 13 in advance, and an initial value of the threshold value used for the potential congestion determination (for example, 70%) and an initial value of the threshold value used for the congestion determination (for example, 90%) may be set in advance.

In this way, when congestion determination area 12 and potential congestion determination area 13, and the threshold value used for the potential congestion determination and the threshold value used for the congestion determination are specified by a user, and EXIT button 66 is operated, setting contents are stored in information storage unit 24 as the user setting information and the processing returns to the monitoring screen (see FIG. 4).

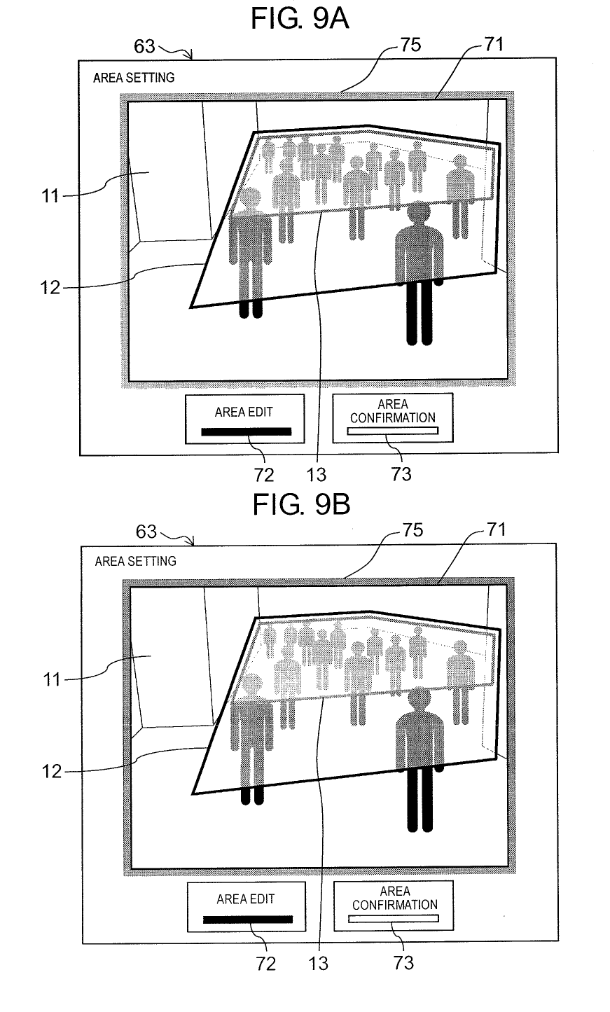

Next, the area setting will be described. FIGS. 9A and 9B are explanatory diagrams showing area setting unit 63 of the setting screen in detail. FIG. 9A shows a case where an editing target is potential congestion determination area 13, and FIG. 9B shows a case where an editing target is congestion determination area 12.

Area setting unit 63 of the setting screen is provided with area input unit 71, area edit button 72, and area confirmation button 73.

In area input unit 71, captured image (camera image) 11 in which the monitoring area is imaged by camera 1 is displayed, and lines representing the boundary of congestion determination area 12 and potential congestion determination area 13 are inputted on the camera image by a user operating an input device such as a mouse. An edit mode is set when area edit button 72 is operated, and congestion determination area 12 and potential congestion determination area 13 can be input to area input unit 71. When area confirmation button 73 is operated, congestion determination area 12 and potential congestion determination area 13 are confirmed with the inputted lines.

In area input unit 71, the lines representing outlines of congestion determination area 12 and potential congestion determination area 13 are displayed in different colors. For example, the lines of congestion determination area 12 are displayed in red, and the lines of potential congestion determination area 13 are displayed in yellow. Inside congestion determination area 12 and potential congestion determination area 13 are filled with a semi-transparent color, so that the inside and outside of congestion determination area 12 and potential congestion determination area 13 can be easily discriminated.

Frame image 75 is displayed on the outer periphery of area input unit 71. When it is moved to the edit mode by operating area edit button 72, the color of frame image 75 is changed in accordance with the editing target (congestion determination area 12 or potential congestion determination area 13). As shown in FIG. 9A, when the editing target is potential congestion determination area 13, frame image 75 is displayed in yellow that is the same color as the line of potential congestion determination area 13, and as shown in FIG. 9B, when the editing target is congestion determination area 12, frame image 75 is displayed in red that is the same color as the line of congestion determination area 12.

Further, in the edit mode, lines before editing of congestion determination area 12 and potential congestion determination area 13 already set by the initial setting and the user setting are displayed, and new lines can be input while watching the lines before editing. At this time, the colors of the lines before editing of determination areas 12 and 13, which are editing targets, are displayed lightly, so that it is possible to discriminate between the lines before editing and the lines being edited.

Note that camera image 11 displayed on area input unit 71 may be a still image. However, an appropriate reproduction operator may be provided on the setting screen so that camera image 11 can be reproduced with a moving image.

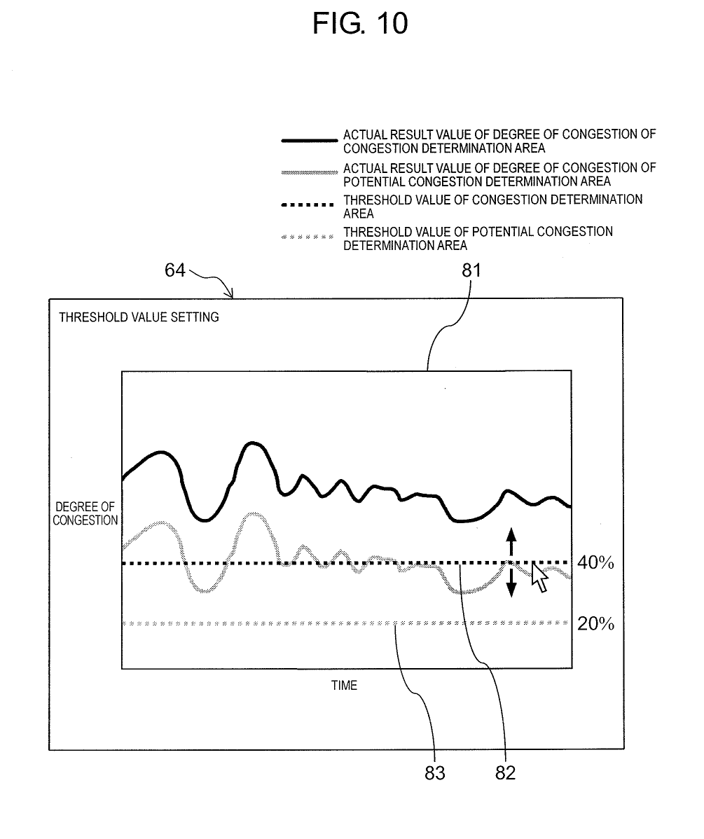

Next, threshold value setting will be described. FIG. 10 is an explanatory diagram showing threshold value setting unit 64 of the setting screen in detail. An example is shown in which the threshold value is changed in a period determined to be congested.

In threshold value setting unit 64 of the setting screen, graph displayer 81 is provided. In graph displayer 81, two graphs representing a temporal transition condition of the actual result value of the congestion degree of congestion determination area 12 and potential congestion determination area 13 are displayed. In the graph, a horizontal axis represents time and a vertical axis represents the congestion degree. Further, in the graph, the congestion degree in a range back to the past by a predetermined period (for example, 2 hours) from the present is displayed, and the right end of the graph is the degree of current congestion. The graph is updated every calculation period of the congestion degree (for example, 5 seconds). Note that, when introducing the system, there is no actual result value of the congestion degree, so the graph is not displayed.

In graph displayer 81, bar 82 representing the threshold value used for the congestion determination and bar 83 representing the threshold value used for the potential congestion determination are displayed on the graphs. These two bars 82 and 83 can be moved upward or downward by an operation (dragging) of an input device such as a mouse, whereby the threshold value used for the congestion determination and the threshold value used for the potential congestion determination can be specified separately. When a transition is made to the setting screen, bars 82 and 83 are displayed at positions corresponding to the threshold values already set by the initial setting and the user setting, and the threshold values can be changed by moving bars 82 and 83 upward or downward.

As described above, in the present exemplary embodiment, since a graph representing a transition condition of the actual result value of the congestion degree is displayed, the threshold value can be set while watching the transition condition of the actual result value of the congestion degree.

Note that the threshold value used for the congestion determination and the threshold value used for the potential congestion determination may be set to the same value.

Further, a user selects a camera screen that is determined visually as the potential congestion state from the past camera images, thereby acquiring the congestion degree from the camera screen, and the congestion degree may be set as a threshold value used for the potential congestion determination. Similarly, the user selects a camera screen that is determined visually as the congestion state, thereby acquiring the congestion degree from the camera screen, and the congestion degree may be set as a threshold value used for the congestion determination.

Further, time can be specified in graph displayer 81, for example, when an operation (click) for selecting a required position on the graph is performed and the time corresponding to the selected position is specified, the camera image at the time may be displayed on area input unit 71 (see FIG. 8) of area setting unit 63. In this way, the threshold value can be adjusted while checking the actual condition with the camera image and the operation for setting the threshold value can be efficiently performed.

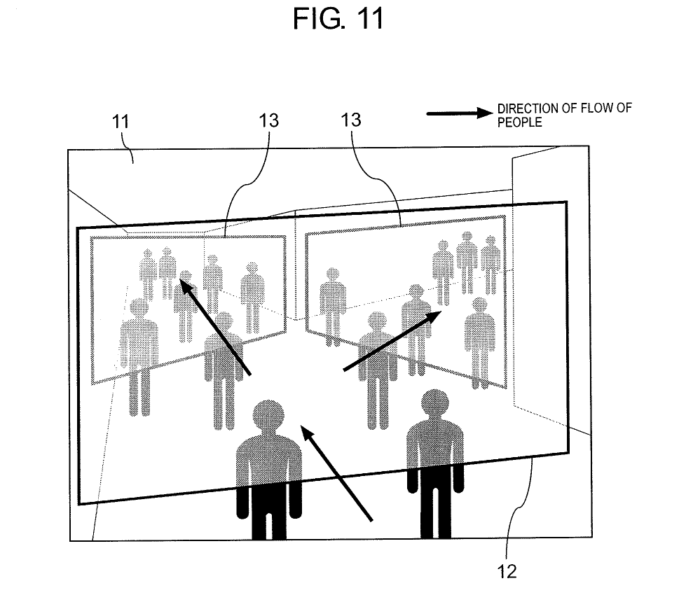

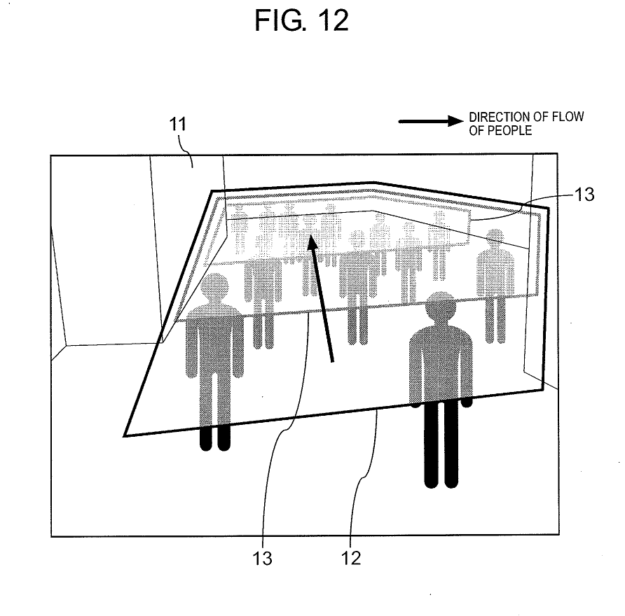

Next, another example of potential congestion determination area 13 set on camera image 11 will be described. FIGS. 11 and 12 are explanatory diagrams showing another example of potential congestion determination area 13.

In the example shown in FIG. 2, one potential congestion determination area 13 is set on camera image 11, but as shown in FIGS. 11 and 12, a plurality of potential congestion determination areas 13 may be set on camera image 11.

In the example shown in FIG. 11, a flow of people is branched in two directions, and two potential congestion determination areas 13 are set in two branch destination areas, respectively. Congestion determination area 12 is set to include both the branch destination area and the branch source area.

In the example shown in FIG. 2, since the flow of people is in one direction, it may be sufficient to set one potential congestion determination area 13 on the downstream side of the flow of people, but as shown in FIG. 11, when the flow of people is branched in two directions, the potential congestion determination cannot be accurately performed unless potential congestion determination areas 13 are set in each of the branch destination areas.

Further, in the example shown in FIG. 12, two potential congestion determination areas 13 are set for the flow of people in one direction. In this way, the potential congestion determination can be performed in two stages. Thus, the potential congestion determination can be accurately performed and the potential congestion state can be notified in two stages.

In the examples shown in FIGS. 11 and 12, two potential congestion determination areas 13 are set. However, depending on the condition of the flow of people in the monitoring area, three or more potential congestion determination areas 13 may be set.

As described above, the exemplary embodiment has been described as an example of the technology disclosed in the present application. However, the technology in the present disclosure is not limited to the above exemplary embodiment, and can also be applied to embodiments in which change, replacement, addition, omission, or the like are performed. In addition, it is also possible to combine each component described in the above exemplary embodiment to provide a new exemplary embodiment.

For example, in the above-described exemplary embodiment, an example in which a target moving body is a person, is described. However, it is also possible to apply the exemplary embodiment to the purpose of grasping the activity condition of a vehicle with a moving object other than a person, for example, a vehicle such as an automobile or a bicycle, as an object.

In the above-described exemplary embodiment, processing for sensing the congestion state in a facility with congestion sensing device 2 installed in the facility is performed. However, processing for sensing the congestion state in the facility may be performed with a server device (cloud computer) connected to a camera via a wide area network.

### INDUSTRIAL APPLICABILITY

The congestion sensing device, the congestion sensing system, and the congestion sensing method according to the present disclosure have the effect of allowing a supervisor to ascertain an occurrence of a congestion state in advance by performing an appropriate notification prior to the congestion state being reached, and it is useful for sensing the congestion state of moving objects in a monitoring area based on a captured image in which the monitoring area is imaged, as the congestion sensing device, the congestion sensing system, the congestion sensing method, or the like.

### REFERENCE MARKS IN THE DRAWINGS

1 CAMERA
2 CONGESTION SENSING DEVICE
3 NOTIFICATION DEVICE
4 PORTABLE TERMINAL
11 CAMERA IMAGE
12 CONGESTION DETERMINATION AREA
13 POTENTIAL CONGESTION DETERMINATION AREA
21 MONITOR (DISPLAY DEVICE)
22 NETWORK COMMUNICATOR
23 CONTROLLER
24 INFORMATION STORAGE UNIT
31 LAMP
32 BUZZER
41 AREA SETTING UNIT
42 REFERENCE VALUE SETTING UNIT
43 PERSON SENSOR (MOVING OBJECT SENSOR)
44 CONGESTION DEGREE CALCULATOR
45 STATE SENSOR
46 OUTPUT UNIT

1. A congestion sensing device for sensing a congestion state of a moving object in a monitoring area based on a captured image in which the monitoring area is imaged, the device comprising:
an area setting unit that sets at least two determination areas on the captured image in response to an input operation of a user;
a moving object sensor that senses a moving object existing within the determination area from the captured image;
a congestion degree calculator that calculates a congestion degree for each of the determination areas based on a sensing result by the moving object sensor;
a state sensor that compares the congestion degree calculated by the congestion degree calculator with predetermined reference values for each of the determination areas, and senses a plurality of states including a congestion state and a potential congestion state; and
an output unit that outputs information for performing a notification action based on the sensing result by the state sensor.

2. The congestion sensing device of claim 1, wherein
the area setting unit sets a congestion determination area, which is an object of a congestion determination for determining whether or not it is in the congestion state, and a potential congestion determination area, which is an object of a potential congestion determination for determining whether or not it is in the potential congestion state, as the determination area.

3. The congestion sensing device of claim 1, wherein
the reference values are set to different values for each of the determination areas.

4. The congestion sensing device of claim 1,
wherein the state sensor senses three states of a normal state, the potential congestion state, and the congestion state, and
wherein the output unit outputs information for performing the notification action according to the three states.

5. The congestion sensing device of claim 1,
wherein the output unit outputs control information for changing a lighting state of a lamp based on the sensing result by the state sensor to a notification device including the lamp.

6. The congestion sensing device of claim 1,
wherein the area setting unit sets a plurality of potential congestion determination areas, which are objects of potential congestion determination for determining whether or not it is in the potential congestion state, on the captured image.

7. The congestion sensing device of claim 1, further comprising:
a reference value setting unit that causes a display device to display a setting screen and sets the reference value in response to an input operation of a user,
wherein the reference value setting unit causes the setting screen to display an actual result value of the congestion degree in the past.

8. A congestion sensing system for sensing a congestion state of a moving object in a monitoring area based on a captured image in which the monitoring area is imaged, the system comprising:
a camera that images the monitoring area; and
a congestion sensing device,
wherein the congestion sensing device includes
an area setting unit that sets at least two determination areas on the captured image in response to an input operation of a user,
a moving object sensor that senses a moving object existing within the determination area from the captured image,
a congestion degree calculator that calculates a congestion degree for each of the determination areas based on a sensing result by the moving object sensor,
a state sensor that compares the congestion degree calculated by the congestion degree calculator with predetermined reference values for each of the determination areas, and senses a plurality of states including the congestion state and a potential congestion state, and
an output unit that outputs information for performing a notification action based on the sensing result by the state sensor.

9. A congestion sensing method for causing an information processing device to perform a process of sensing a congestion state of a moving object in a monitoring area based on a captured image in which the monitoring area is imaged, the method comprising:
setting at least two determination areas on the captured image in response to an input operation of a user;
sensing the moving object existing within the determination area from the captured image;
calculating a congestion degree for each of the determination areas based on the sensing result;
comparing the congestion degree obtained in the calculating of the congestion degree with predetermined reference values for each of the determination areas, and sensing a plurality of states including the congestion state and a potential congestion state; and
outputting information for performing a notification action based on the sensing result.
